(19) United States
(12) Patent Application Publication
(10) Pub. No.: US 2002/0097582 A1
(43) Pub. Date: Jul. 25, 2002

(54) THIN SHEET-TYPE ILLUMINATOR STRUCTURE

(76) Inventor: Chung-Yang M. Chen, Hsintien City (TW)

Correspondence Address: BACON & THOMAS, 4th Floor, 625 Slaters Lane, Alexandria, VA, 22314, US

(21) Appl. No.: 09/768,608

(22) Filed: Jan. 25, 2001

(51) Int. Cl. F21V 33/00

(52) U.S. Cl. 362/362; 362/812

(57) ABSTRACT

Thin sheet-type illuminator structure including a casing made of transparent material and having a form of thin sheet. The casing is partially covered by a covering section in which electric elements for illumination are arranged. A color is painted onto or a color film is attached to the outer or inner face of the covering section. The covering section has a border having configurations or patterns of lines. A picture/word card or photograph is sandwiched in the casing. The border of the covering section partially overlaps and covers the edge of the picture/word card. The illuminator not only can provide an illumination functions but also can display the pictures or words. The patterned border of the covering section serves to beautify the edge of the displayed pictures or words.

### BACKGROUND OF THE INVENVTION

The present invention is related to a thin sheet-type illuminator structure which has light weight and thin thickness and can be easily carried. The thin sheet-type illuminator is formed with a transparent section through which preset pictures or words are displayed so as to additionally achieve advertising, reminding or memorizing function.

It is a trend to develop mini-type portable illuminators such as pen-type flashlight. Such mini-type portable illuminator has small volume and can be easily carried. However, there are still some shortcomings existing in such mini-type portable illuminators. For example, the pen-type is only suitable to be placed in the pocket of a shirt, while being unsuitable to be placed in the pocket of a pants. Moreover, such pen-type illuminator lacks any additional function. An improved product has been developed, in which the illuminator is combined with a ball-point pen or laser indicator pen to achieve additional function. However, it is still not so convenient to carry such pen-type illuminator. Also, such pen-type illuminator still can hardly provide additional function with higher value.

It is therefore a primary object of the present invention to provide a thin sheet-type illuminator structure including a casing having a form of thin sheet. The casing is partially formed with a transparent section with a certain area. A picture/word card or photograph is sandwiched in the transparent section, whereby the illuminator not only can provide an illumination function, but also can display the pictures or words through the transparent section to additionally achieve advertising, reminding or mermorizing function.

It is a further object of the present invention to provide the above thin sheet-type illuminator structure in which the casing is partially covered by a covering section in which electric elements for illumination are arranged. The covering section has a border taking forms of various configurations or patterns of lines. The border is adjacent to and cover the edge of the transparent section. The patterned border serves to beautify the edge of the displayed pictures or words and enhance the displaying effect.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invent ion;

FIG. 3 is a perspective assembled view of another embodiment of the present invention; and

FIG. 4 is a perspective assembled view of still another embodiment of the present invention.

### DETAILED DESCRPTION OF THE PREFERRED EMBODLIIENTS

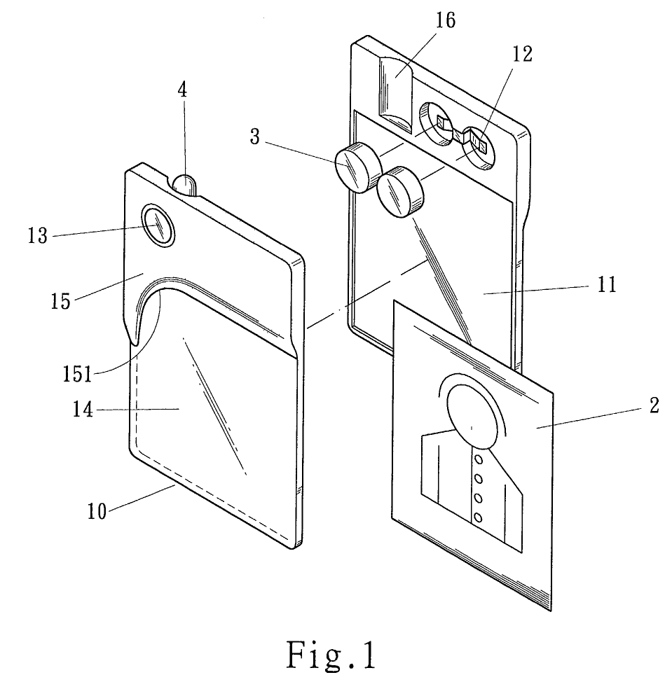

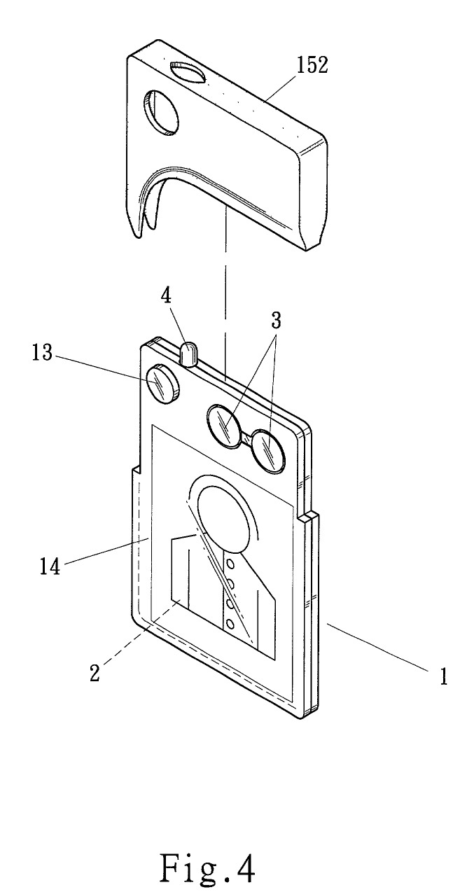

Please refer to FIG. 1. The present invention includes a casing 1, a picture/word card 2, cells 3 and a light source 4. The casing 1 is made of transparent material. The casing 1 can be made by integral molding. Alternatively, the casing 1 can be composed of several pieces 10 assembled with each other, At least one side of the casing 1 is formed with a transparent section 14. In addition, the casing 1 is partially covered by a covering section 15 beside the transparent section 14. The border 151 of the covering section 15 takes forms of various configurations or patterns of lines. A color is painted or sprayed on the surface or inner face of the covering section 15 or a color pictured film is attached thereto for shading the inner side. Alternatively, as shown in FIG. 4A the cover section 15 can be formed by a separate shade body 152 fitted =around a part of the casing 1. A power switch 13 is arranged on the front side of the covering section 15 or other part of the casing 1. At least one cell seat 12 is disposed in the casing 1 behind the covering section 15. A mini-type cell 3 such as button-shaped cell is received in the cell seat 12. An edge of the covering section is formed with a cavity 16 in which the light source 4 (such as a small bulb) is inlaid. The transparent section 14 is formed with an internal receptacle 11. The picture/word card 2 is a thin sheet. At least one side of the surface of the picture/word card 2 is printed with certain pictures or words as necessary. The picture/word card 2 can be placed into the receptacle 1.

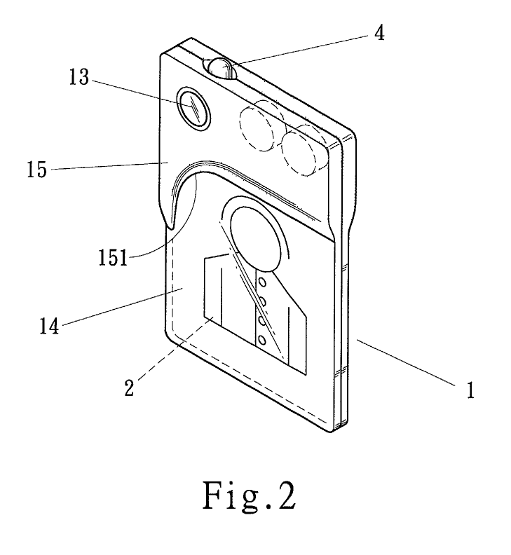

Referring to FIG. 2, when assembled, the picture/word card 2 is first placed into the receptacle 11 of the casing 1. Then the cells 3 are placed into the cell seats 12. The light source 4 is inlaid into the cavity 16. Then the pieces 10 are mated with each other and sealed by an adhesive or ultrasonic wave. After assembled, the pieces 10 are bonded with each other to form the casing 1. Tec picture/word card 2, cells 3 and light source 4 are sandwiched between the pieces 10. By means of pressing the power switch 13, the light source 4 can be turned on or off for providing illumination function. The picture/word card 2 in the casing 1 is presented to outer side through the transparent section 14 so as to achieve predetermined advertising, reminding or memorizing function. The picture/word card 2 can be alternatively a photograph.

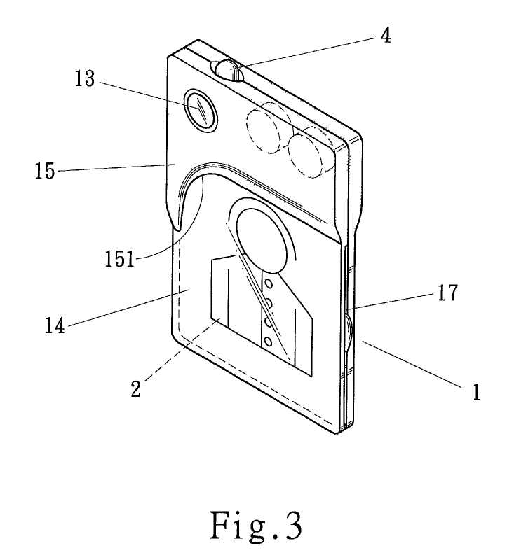

The covering section 15 extends through the surface of the casing 1 in a certain pattern to cover the cells 3, cell seats 12 and light source 4. In addition, the various configurations or patterns of the lines of the border of the covering section 15 serves to beautify picture/word card 2 and enhance the decoration effect. color plastic film can be attached to the surface of the covering section 15 instead of the color sprayed thereon to achieve the same shading effect. Alternatively, the picture/word card 2 can De positioned in the casing 1 in such a manner that prior to molding, the picture/word card 2 is previously sealed in the casing 1. Alternatively, the casing 1 can be formed by several pieces 10 which can be disassembled for replacement of the picture/word card 2. In addition, the wail of the casing 1 can be formed with a slit 17 corresponding to the receptacle 11, whereby the picture/word card 2 can be selectively replaced through the slit 17 as shown in FIG. 3.

According to the above arrangement, the thin sheet-type illuminator of the present invention has light weight and small volume and thus can be easily carried. Moreover, the thin sheet-type illuminator of the present invention is able to display the preset pictures or words so as to achieve advertising, reminding or memorizing function.

The above embodiments are only used to illustrate the present invention, not intended to limit the scope thereof. Manly modifications of the above embodiments can be made without departing from the spirit of the present invention.

What is claimed is:

1. Thin sheet-type illuminator structure comprising:
a casing made of transparent material and having a form of thin sheet, a light source being disposed at one end of the casing, two faces of the casino being partially covered by a covering section, remaining section of the casing being a transparent section, electric elements for illumination being arranged in the casing behind the covering section, the casing being formed with an internal receptacle; and
a picture/word card sandwiched in the receptacle of the casing, at least one side of the surface of the picture/word card being provided with certain pictures or words as necessary, the pictures or words being presented to outer side through the transparent section, whereby the casing not only can provide an illumination function, but also is able to display the pictures or words so as to additionally achieve advertising or displaying function, a border of the covering section adjacent to the transparent section being patterned to have a partitioning and decorating shape.

2. Thin sheet-type illuminator structure as claimed in claim 11, wherein the receptacle of the casing extends in the casing and partially overlaps the covering section.

3. Thin sheet-type illuminator structure as claimed in claim 1, wherein the covering section is formed by a separate shade body fitted around a part of the casing.

4. Thin sheet-type illuminator structure as claimed in claim 1, wherein the covering section is formed by directly attaching a color plastic film to the casing.

5. Thin sheet-type illuminator structure as claimed in claim 3, wherein the covering section is formed by directly attaching a color plastic film to the casing.

6. Thin sheet-type illuminator structure as claimed in claim 1, wherein the covering section is formed by spraying a color onto the casing.

7. Thin sheet-type illuminator structure as claimed in claim 3, wherein the covering section is formed by spraying a color onto the casing.

8. Thin sheet-type illuminator structure as claimed in claim 1, wherein the border of the covering section takes form of a straight line or curved line.

9. Thin sheet-type illuminator structure as claimed in claim 3, wherein the border of the covering section takes form of a straight line or curved line.

10. Thin sheet-type illuminator structure as claimed in claim 1, wherein the border of the covering section is patterned border.

11. Thin sheet-type illuminator structure as claimed in claim 3, wherein the border of the covering section is a patterned border.

12. Thin sheet-type illuminator structure as claimed in claim 1, wherein the electric elements for illumination include cells, light source and power switch.

13. Thin sheet-type illuminator structure as claimed in claim 3, wherein the electric elements for illumination include cells, light source and power switch.

14. Thin sheet-type illuminator structure as claimed in claim 1, wherein the picture/word card is a photograph.

15. Thin sheet-type illuminator structure as claimed in claim 3, wherein the picture/word card is a photograph.

16. Thin sheet-type illuminator structure as claimed in claim 1, wherein the casing is formed by several separate pieces mated with each other.

17. Thin sheet-type illuminator structure as claimed in claim 3, wherein the casing is formed by several separate pieces mated with each other.

18. Thin sheet-type illuminator structure as claimed in claim 1, wherein the casing is formed with a slit corresponding to the receptacle, whereby the picture/word card can be directly drawn out and replaced through the slit.

19. Thin sheet-type illuminator structure as claimed in claim 3, wherein the casing is formed with a slit corresponding to the receptacle, whereby the picture/word card can be directly drawn out and replaced through the slit.
